(19) United States
(12) Patent Application Publication
(10) Pub. No.: US 2012/0188945 A1
(43) Pub. Date: Jul. 26, 2012

(54) ROUTE OPTIMIZATION METHOD AND ACCESS ROUTER

(75) Inventor: Xiangsong Cui, Beijing (CN)

(73) Assignee: Huawei Technologies Co., Ltd, Shenzhen (CN)

(21) Appl. No.: 13/440,705

(22) Filed: Apr. 5, 2012

Related U.S. Application Data
(63) Continuation of application No. PCT/CN2010/077685, filed on Oct. 12, 2010.

(30) Foreign Application Priority Data
Oct. 16, 2009 (CN) 200910110531.5

(51) Int. Cl. H04W 24/00; H04W 40/00

(52) U.S. Cl. 370/328

(57) ABSTRACT

A route optimization method and an access router are disclosed. The route optimization method includes: an access router receives a test initiation message sent by a source IP node that initiates route optimization; determine a destination IP node of the route optimization according to the test initiation message; and establish route optimization between the source IP node and the destination IP node in place of the destination IP node. Therefore, the destination IP node that receives the route optimization can implement route optimization through the access router even if the route optimization in the mobile IPv6 protocol is not supported.

### CROSS-REFERENCE TO RELATED APPLICATIONS

This application is a continuation of International Application No. PCT/CN2010/077685, filed on Oct. 12, 2010, which claims priority to Chinese Patent Application No. 200910110531.5, filed on Oct. 16, 2009, both of which are hereby incorporated by reference in their entireties.

### FIELD OF THE DISCLOSURE

The present disclosure relates to the field of wireless communication, and in particular, to a route optimization method and an access router.

### BACKGROUND

The IPv6 is a protocol formulated by the IETF (The Internet Engineering Task Force, Internet Engineering Task Force) for network interconnection. The IPv6 overcomes drawbacks of the IPv4 technology such as address deficiency and inferior support of mobility and security. Further, the IETF extends the IPv6 protocol, and releases a mobile IPv6 (MIPv6) standard that supports mobility management. The mobile IPv6 standard enables a mobile IP node to move freely while keeping session connectivity, which greatly enhances convenience of a user in using the IP protocol for communication and session.

In the mobile IPv6 technology, a home agent is used as a mobility management anchor of the mobile node. The home agent is a router capable of mobility management. In a basic mobile IPv6 solution, the mobile node gets registered onto the home agent, and the home agent stores the binding relationship between a home address and a care-of address. Any IP packet destined for the home address of a mobile node can be forwarded to the mobile node through the home agent by using a care-of address. When the mobile node moves to a new location, the mobile node can move freely by only updating the care-of address stored in the home agent. A home address refers to an IP address allocated to a mobile node permanently. No matter how the access point of the mobile node changes, the home address always keeps unchanged. A care-of address is a termination address of a tunnel directed to the mobile node when the host sends a packet to the mobile node that moves out of the home network. The home agent is a router located on the home network of the mobile node. When the mobile node leaves the home network, the router maintains the current location information of the mobile node, and forwards the information destined for the mobile node to the mobile node through a tunnel.

In a basic mode of the mobile IPv6, all service data needs to be forwarded by the home agent. Consequently, the node load of the home agent increases, and the forwarding step increases the delay of transmitting the IP data and leads to waste of network resources. Moreover, the reliability of the session may be decreased by adding of a key node because all sessions will fail once the node device of the home agent is faulty.

To overcome drawbacks of the basic mode of the mobile IPv6, the IETF adds a new working mode in the mobile IPv6 standard: route optimization. Route optimization allows the mobile IP node to bind its address to the peer IP node, namely, the opposite IP node being engaged in an IP session with the mobile IP node. That is, the peer IP node stores the home address and the care-of address of the mobile IP address, and the binding relationship between them. To implement the route optimization solution, the IETF clarifies the extension that needs to be supported by the mobile IP node and the peer IP node. The mobile IP node cannot implement route optimization with the peer IP node unless such specific functions are fulfilled. However, because the capabilities of the peer IP node do not necessarily support route optimization, the implementation of the route optimization may fail.

### SUMMARY

An embodiment of the present disclosure provides a method and an apparatus for implementing route optimization so that the route optimization is still enabled even if a destination IP node that receives the route optimization does not support the route optimization in the mobile IPv6 protocol.

An embodiment of the present disclosure provides a route optimization method, including: receiving, by an access router, a test initiation message sent by a source IP node that initiates route optimization; determining a destination IP node of the route optimization according to the test initiation message; and establishing route optimization between the source IP node and the destination IP node in place of the destination IP node.

An embodiment of the present disclosure provides an access router, which is connected between a source IP node that initiates route optimization and a destination IP node of the route optimization. The access router includes: a receiving unit, configured to receive a test initiation message sent by the source IP node that initiates route optimization, and send the test initiation message to a destination node determining unit; and a destination node determining unit, configured to determine the destination IP node of the route optimization according to the test initiation message sent by the receiving unit; and a route optimization establishment unit, configured to establish route optimization between the source IP node and the destination IP node in place of the destination IP node after the destination node determining unit determines the destination IP node of the route optimization.

In the embodiments of the present disclosure, the access router that connects the destination IP node implements the route optimization in place of the destination node, and therefore, the source mobile IP node can communicate with the destination IP node without through its home agent. The IP packet sent by the destination IP node to the source IP node is not necessarily forwarded by the home agent of the source IP node, which accomplishes route optimization and extends the applicable scope of the route optimization in the mobile IPv6. The destination IP node that receives the route optimization can implement route optimization through the access router even if the route optimization in the mobile IPv6 protocol is not supported.

### BRIEF DESCRIPTION OF THE DRAWINGS

FIG. 1 is a flowchart of a route optimization method according to an embodiment of the present disclosure;

FIG. 2 is a flowchart of another route optimization method according to an embodiment of the present disclosure;

FIG. 3 is a schematic structural diagram of an access router according to an embodiment of the present disclosure; and

FIG. 4 is a schematic structural diagram of another access router according to an embodiment of the present disclosure.

### DETAILED DESCRIPTION OF THE EMBODIMENTS

To make the solution, objectives and merits of the present disclosure clearer, the following describes the embodiments of the present disclosure in more detail with reference to the accompanying drawings.

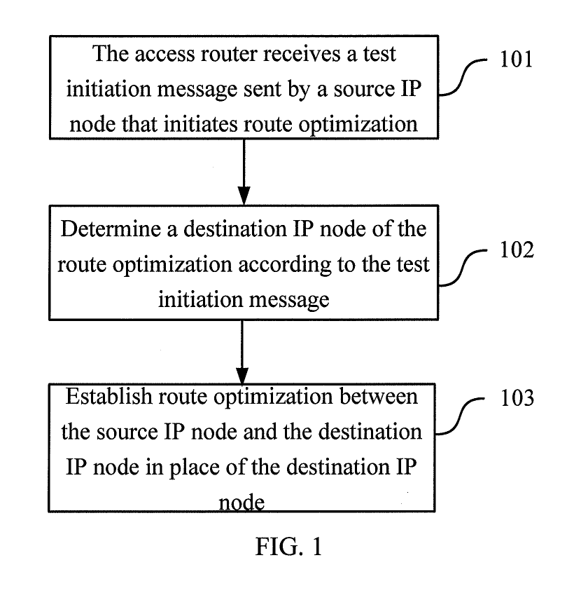

FIG. 1 is a flowchart of a route optimization method according to an embodiment of the present disclosure. The method includes the following steps:

Step 101: Receive a test initiation message sent by a source IP node that initiates route optimization.

The entity that performs this receiving step is an access router that connects the destination IP node which the source IP node expects to implement the route optimization. The test initiation message may be a home test initiation message and/or a care-of test initiation message. As used herein, the term “and/or” includes any and all combinations of one or more of the associated listed items. That is, the access router may receive the home test initiation message and the care-of test initiation message simultaneously and process each of the two test initiation messages, or may receive the home test initiation message and the care-of test initiation message separately and process each of them. The home test initiation message is sent by the source IP node to the destination IP node through a home agent, and the care-of test initiation message is sent by the source IP node to the destination IP node. The two test initiation messages may be sent in the form of an IP packet. The access router determines whether the IP packet is a home test initiation message or a care-of test initiation message according to the header field and the extension header field of the IP packet.

The method of determining the type of an IP packet according to the header field and the extension header field of the IP packet may include: After receiving the IP packet, the access router checks the header field (IPv6 Header) and the extension header field (IPv6 Extension Header) of the IP packet to see whether the next header (Next Header) field of the two fields includes a mobility extension header (Mobility Header) of a 135 type. If the IP packet includes a next header whose value is 135, it indicates that the next extension header of the IP packet is a mobility extension header for mobility management; otherwise, the IP packet is another packet irrelevant to mobility management, namely, a packet irrelevant to route optimization. If the IP packet includes the extension header, the access router further checks the value of the mobility header type (MH Type) field in the mobility extension header. For example, if the value of the mobility header type field is 1, it indicates that the IP packet is a home test initiation message; if the value of the mobility header type field is 2, it indicates that the IP packet is a care-of test initiation message; if the value of the mobility header type field is 5, it indicates that the IP packet is a binding update message. Provided above is only an example of a method of determining the IP packet type according to the header field and the extension header field of the IP packet. This embodiment is not limited to that example, and other methods may also be used to identify the type of an IP packet. Any method for determining the type of an IP packet shall fall within the protection scope of the present disclosure.

Step 102: Determine the destination IP node of the route optimization according to the test initiation message.

In this step, the access router can determine the destination IP node of the route optimization according to the destination IP address included in the test initiation message.

Optionally, if the access router locally stores policy configuration information that is set for each of different IP nodes that are connected to the access router and is used to indicate whether it is necessary to implement route optimization in place of the IP node for each different IP node respectively, and after step 102, the method may further include: The access router determines necessity of establishing route optimization between the source IP node and the destination IP node in place of the destination IP node according to the local policy configuration data and the destination IP node of the determined route optimization. A default configuration may be: The access router needs to implement route optimization for a connected IP node, without the need of making determination according to different destination IP nodes. Therefore, the step of determining necessity of establishing route optimization in place of the destination IP node according to the policy configuration information and the destination IP node is optional, and is not a necessary feature of this embodiment of the present disclosure.

Step 103: Establish route optimization between the source IP node and the destination IP node in place of the destination IP node.

When the access router establishes route optimization in place of the destination IP node, the access router sends a home test message to the source IP node through the home agent of the source IP node, and sends a care-of test message to the source IP node; afterward, the access router receives a binding update message that is returned by the source IP node in response to the home test message and the care-of test message; the access router stores and binds the home address and the care-of address carried in the binding update message, and the IP address of the destination IP node, namely, establishes a binding relationship between the home address, the care-of address, and the IP address of the destination IP node; and the access router returns a binding acknowledgement message to the source IP node. The source IP address of the binding acknowledgment message is the IP address of the destination IP node, or the IP address of the access router itself. The binding acknowledgment message carries a proxy acknowledgement indication or a mobile network acknowledgement indication, indicating to the source IP node that the binding acknowledgement message is a response message returned by the access router in place of the destination IP node. By now, the access router has established the route optimization between the source IP node and the destination IP node in place of the destination IP node.

It should be noted that after the route optimization is established, because the IP packet length may change when the route optimization is performed by the access router by proxy, the access router may instruct the destination IP node to adjust a Minimum Transmission Unit (MTU) to a specific value, and therefore, when the access router performs route optimization and forwards the IP packet, the access router uses the care-of address to replace the home address as a destination IP address of the IP packet header, and/or inserts the home address into the extension header of the IP packet, without going beyond the limit of the MTU.

The access router stores and binds the home address and the care-of address carried in the binding update message, and the IP address of the destination IP node, and therefore, when the access router forwards the IP service data packet such as the first IP packet sent by the destination IP node to the source IP node subsequently, the access router can use the care-of address of the source IP node in the binding relationship to replace the originally used home address of the source IP node as the destination IP address in the first IP packet header field, and send the first IP packet to the care-of address of the source IP node, so that all IP service data packets are IP-routed according to the care-of address. Therefore, the IP packet sent by the destination IP node to the source IP node does not need to be forwarded through the home agent of the source IP node, which accomplishes route optimization. The first IP packet refers to any IP packet sent by the destination IP node to the source IP node after the route optimization is established, and the name “first IP packet” shall not be construed as limitation on the present disclosure.

In addition, after receiving the binding acknowledgement message, the source IP node may perform IP routing for the IP data destined for the destination IP node according to the IP address of the destination IP node directly, and the IP data does not need to be forwarded by the home agent any longer.

Through the method provided in this embodiment, the applicable scope of route optimization in the mobile IPv6 is extended. The destination IP node that receives the route optimization can still implement route optimization even if the route optimization in the mobile IPv6 protocol is not supported. The destination IP node may be any IPv6 node that supports the basic IPv6 protocol, and may be a fixed terminal connected in a wired mode or a mobile terminal connected in a wireless mode.

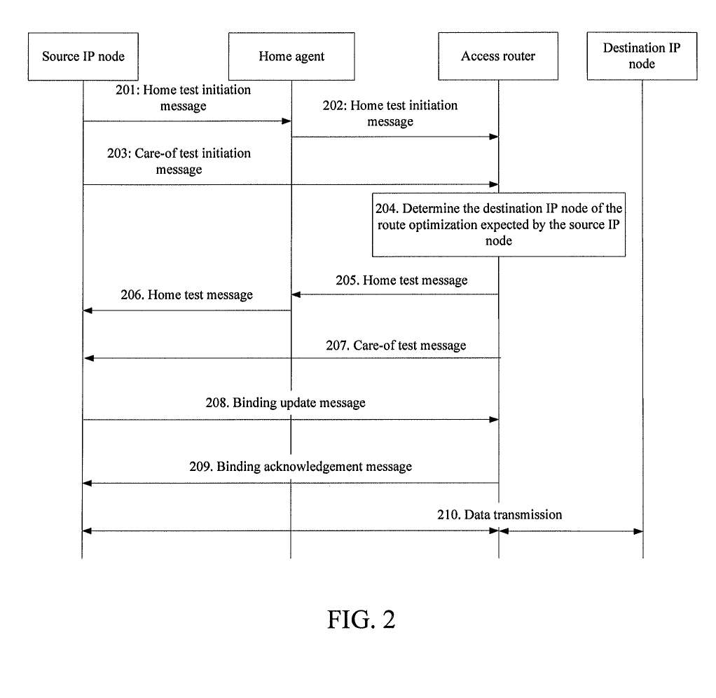

FIG. 2 is a flowchart of another route optimization method according to an embodiment of the present disclosure. The method includes the following steps:

Step 201: The source IP node that initiates route optimization sends a home test initiation (Home Test Init) message to the home agent. The source IP address of the message is the home address of the source IP node, and the destination IP address is the IP address of the destination IP node of the route optimization.

In this embodiment, the source IP node refers to the IP node that initiates the route optimization in the process of implementing the route optimization; and the destination IP node refers to the destination IP node with which the source IP node expects to implement route optimization in the process of implementing the route optimization. The source IP node supports the route optimization function; and the destination IP node may support the route optimization function or not. If the destination IP node supports the route optimization function, either the route optimization establishment function provided by the destination IP node or the route optimization establishment function provided by the access router may be applied. If the destination IP node supports the route optimization function, and, if the route optimization establishment function provided by the access router is applied, the access router also establishes the route optimization by using the method provided in the embodiment of the present disclosure.

Step 202: The home agent forwards the home test initiation message to the destination IP node, and the message is forwarded to the destination IP node according to the destination IP address in the home test initiation message.

It should be noted that because the access router that connects the destination IP node is the network device of the last hop that is inevitable when the destination IP node receives an IP packet from the IP network, therefore, the access router can receive the IP packet destined for the destination IP node, such as the home test initiation message.

When the home agent forwards the home test initiation message to the destination IP node, the home agent searches the IP routing table stored by itself, and sends the home test initiation message to the next-hop router or next-hop network device on the IP route of the destination IP node. That is, the home agent sends the home test message to the access router that connects the destination IP node through a one-hop route or a multi-hop route.

Step 203: The source IP node sends a care-of test initiation (Care-of Test Init) message to the destination IP node. The source IP address of the message is the care-of address of the source IP node, and the destination IP address is the IP address of the destination IP node.

It should be noted that no definite order exists between step 203 and steps 201 and 202.

Step 204: The access router that connects the IP node receives the test initiation message (home test initiation message and/or care-of test initiation message) destined for the destination IP node, and, according to the destination IP address carried in the test initiation message, determines the destination IP node which the source IP node expects to implement the route optimization; as a route optimization agent of the destination IP node, the access router processes the test initiation messages in place of the destination IP node. For the detailed handling process, see the subsequent steps.

Optionally, if the access router stores locally policy configuration information that is set for each of different IP nodes that are connected to the access router and is used to indicate whether it is necessary to implement route optimization in place of the IP node for each different IP node respectively, and after the destination IP node is determined for the route optimization expected by the source IP node, the method may further include: The access router determines necessity of establishing route optimization between the source IP node and the destination IP node in place of the destination IP node according to the local policy configuration data and the destination IP node of the determined route optimization.

A default configuration may be: The access router needs to implement route optimization for a connected IP node, without the need of making determination according to different destination IP nodes. Therefore, the step of determining necessity of establishing route optimization in place of the destination IP node according to the policy configuration information and the destination IP node is optional, and is not a necessary feature of this embodiment of the present disclosure.

The policy configuration data is new attribute data added on the access router in the embodiment of the present disclosure, and the policy indicated by the policy configuration data includes: information indicating whether the access router needs to establish route optimization in place of the destination IP node if the IP node that is connected to the access router acts as a destination of route optimization, and, if the access router receives the home test initiation message, care-of test initiation message, or binding update message destined for the destination IP node. After the access router establishes the route optimization in place of the IP node, the route optimization method can be applied so that the data transmission does not need to pass through the home agent of the source IP node any more.

The policy configuration data may include a policy configuration attribute: “participate in route optimization in place of the destination IP node”. For example, the value of the policy configuration attribute may be set to “1” or “0”. When the attribute value is “1”, the access router needs to participate in route optimization in place of the destination IP node by using the method disclosed in the present disclosure; when the attribute value is “0”, the access router may work according to a general procedure, that is, work ignoring the method disclosed in the embodiment of the present disclosure. The policy configuration attribute may be set to other values, and this embodiment provides “0” and “1” as examples only. The policy configuration attribute may also have other names, and “participate in route optimization in place of the destination IP node” is only an exemplary name here. The meaning of participating in route optimization may include establishment of route optimization and application of route optimization.

The test initiation message is sent in the form of an IP packet to the access router that connects the destination IP node, and the access router may determine the type of the message according to the header field and the extension header field of the IP packet, and determine whether the IP packet is a test initiation message. In the prior art, the access router provides only the function of forwarding the IP packet according to the destination IP address of the IP packet; by comparison, in this embodiment, the access router needs to further analyze the type of the IP packet, and process the test initiation message.

Step 205: The access router that connects the destination IP node sends a home test message (Home Test) message to the source IP node. The source IP address of the message is the IP address of the destination IP node, and the destination IP address is the home address of the source IP node.

When the access router sends the home test message to the source IP node, the access router searches the IP routing table stored by itself, and sends the home test message to the next-hop router or next-hop network device on the IP route directed to the source IP node. That is, the access router may send the home test message to the source IP node through a one-hop route or a multi-hop route.

Step 206: After receiving the home test message, the home agent of the source IP node forwards the home test message to the source IP node.

Step 207: The access router that connects the destination IP node sends a care-of test message (Care-of Test) message to the source IP node. The source IP address of the message is the IP address of the destination IP node, and the destination IP address is the care-of address of the source IP node.

It should be noted that: On the basis of ensuring the order between steps 201, 202, 204, 205, and 206, and the order between steps 203, 204, and 207, because no definite order exists between step 203 and steps 205 and 206, and no definite order exists between step 207 and steps 205 and 206, the steps in the foregoing procedure may be adjusted and changed as required. For example, the access router in this embodiment may receive the home test initiation message and the care-of test initiation message simultaneously, and process them by using the method provided in step 204. In another embodiment of the present disclosure, the access router may receive one of the two test initiation messages first, for example, receives the home test initiation message in step 201 and step 202 first, and then perform step 204 in the preceding embodiment to process the home test initiation message. Afterward, the access router performs steps 205 and 206, namely, sends the home test message corresponding to the home test initiation message. Subsequently, the access router receives the other of the two test initiation messages, such as the care-of test initiation message in step 203, and then performs steps 204 and 207 sequentially, namely, sends the care-of test message corresponding to the care-of test initiation message. By analogy, the steps in the procedure of this embodiment may be adjusted in other ways, and the adjustment is not detailed here any further.

Step 208: After receiving the home test message and the care-of test message, the source IP node sends a binding update (Binding Update) message. The source IP address of the message is the care-of address of the source IP node, and the destination IP address is the IP address of the destination IP node. The message further carries the home address of the source IP node.

The binding update message may be sent in the form of an IP packet to the destination IP node. The access router that connects the destination IP node determines the type of the IP packet in a way similar to the method of the access router determining whether the IP packet is a test initiation message in step 204.

Step 209: After receiving the binding update message, the access router that connects the destination IP node stores the home address and the care-of address of the source IP node that are carried in the binding update message in the locally stored data table that is corresponding to the destination IP node and is stored locally, and the access router establishes a binding relationship between the home address, the care-of address, and the IP address of the destination IP node. Then, the access router returns a binding acknowledgement (Binding Acknowledgement) message to the source IP node. The source IP address of the message is the IP address of the destination IP node or the IP address of the access router itself, and the destination IP address is the care-of address of the source IP node. By now, the access router has established the route optimization between the source IP node and the destination IP node in place of the destination IP node. After receiving the binding acknowledgement message, the source IP node may perform IP routing on the IP data destined for the destination IP node according to the IP address of the destination IP node directly, and the IP data does not need to be forwarded by the home agent any longer.

Optionally, after the access router that connects the destination IP node receives the binding update message, the method may further include: The access router determines necessity of establishing route optimization for the destination IP node according to the policy configuration data. The determining method is almost the same as the method in step 204, and is not detailed here any further.

The storing of the address and the establishment of the binding relationship aim at applying route optimization in the subsequent process of data transmission between the destination IP node and the source IP node. The method of applying the route optimization is detailed in step 210.

It should be noted that a packet may undergo multiple hops of forwarding on an IP route between the source IP node and the destination IP node of the route optimization, and the destination IP node may be connected to the IP network in different ways. That is, this embodiment is applicable to multiple scenarios. For example:

As an application scenario of this embodiment, the destination IP node may support no route optimization in the mobile IPv6 protocol, and access the IP network by connecting the mobile router. In this scenario, the mobile router is an access router in this embodiment, and the home agent of the mobile router that connects the destination IP node exists on the IP path between the source IP node and the destination IP node.

In another application scenario of this embodiment, the destination IP node may support no route optimization in the mobile IPv6 protocol, but the access router that connects the destination IP node may support the proxy mobile IPv6 protocol. In this scenario, the access router is called a mobile access gateway, and the destination IP node may access the IP network by connecting to the mobile access gateway. Moreover, a local mobility anchor of the destination IP node exists on the IP path between the source IP node and the destination IP node.

Optionally, the binding acknowledgment message carries indication information, indicating to the source IP node that the binding acknowledgement message is a response message returned by the access router in place of the destination IP node. The mode of carrying the indication information includes: The access router may add a new identifier into the binding acknowledgement message in the prior art. For example, if the access router is the mobile router, mobile router indication information or mobile network indication information may be added into the binding acknowledgement message. If the access router is the mobile access gateway, the indication information of the mobile access gateway indication information or the indication information of the proxy mobile IP may be added into the binding acknowledgement message.

Step 210: The route optimization established between the source IP node and the destination IP node may be applied to the data transmission process: The data transmitted between the source IP node and the destination IP node is forwarded between the source IP node, the access router that connects the destination IP node, and the destination IP, without through the home agent of the source IP node.

It should be noted that after the route optimization is established, because the IP packet length may change when the route optimization is performed by the access router by proxy, the access router may instruct the destination IP node to adjust an MTU to a specific value, and therefore, when the access router performs route optimization and forwards the IP packet, the access router uses the care-of address to replace the home address as a destination IP address of the IP packet header, and inserts the home address into the extension header of the IP packet, without going beyond the limit of the MTU.

When the destination IP node sends an IP service data packet such as the first IP packet to the source IP node, the home address of the source IP node is used as the destination IP address of the first IP packet, and the first IP packet is sent to the access router that connects the destination IP node first. After receiving the first IP packet sent by the destination IP node to the source IP node, the access router determines whether route optimization between the destination IP address of the first IP packet and the source IP address of the first IP packet exists according to the destination IP address of the first IP packet (namely, the home address of the source IP node) and the source IP address of the first IP packet (namely, the IP address of the destination IP node), namely, determines whether route optimization between the source IP node and the destination IP node exists. The specific determination method includes: Determining whether any binding relationship between the destination IP address and the source IP address exists; if the route optimization exists, the access router uses the care-of address of the source IP node in the binding relationship to replace the originally used home address of the source IP node as the destination IP address in the first IP packet header, searches the IP routing table by using the care-of address of the source IP node as the destination IP address, and sends the first IP packet to the next-hop IP device. Through the foregoing method, the first IP packet sent by the destination IP node to the source IP node may be IP-routed according to the care-of address of the source IP node. Therefore, the process of routing the packet to the source IP node does not involve the home agent of the source IP node. It should be noted that in the process of replacing the destination IP address and forwarding the first IP packet, the access router may add the home address of the source IP node into the extension header of the first IP packet to indicate that the first IP packet has undergone route optimization. The IP packet is destined for the home address of the source IP node.

Likewise, the access router may replace the source IP address of the service data packet such as the second IP packet sent by the source IP node to the destination IP node. That is, the access router changes the source IP address of the second IP packet, which is originally the care-of address of the source IP node, to the home address of the source IP node, and sends the second IP packet with the changed address to the destination IP node. In this way, the second IP packet sent by the source IP node to the destination IP node does not need to pass through the home agent of the source IP node.

Through the method provided in this embodiment, the source mobile IP node can communicate with the destination IP node without through its own home agent; the IP packet sent by the destination IP node to the source IP node is no longer forwarded by the home agent of the source IP node, which implements route optimization. A forwarding step is deleted in the data transmission in each of the two directions, which reduces the communication delay and reduces the network load. Moreover, even if the home agent is faulty, the communication with the destination IP node still goes on properly, which enhances reliability of communication. Moreover, the home agent serves the mobile node in a one-to-many relationship. Therefore, when there are many mobile nodes, the home agent becomes a key bottleneck node, and the method provided in the embodiment of the present disclosure prevents faults caused by overload of the home agent.

Compared with the practice of extending the mobile terminal to make it support the mobile IPv6 or support the route optimization function, this embodiment of the present disclosure extends the access router functions, which is faster, convenient, cost-efficient, and easier to implement.

Persons of ordinary skill in the art should understand that all or part of the steps of the method provided in any embodiment of the present disclosure may be implemented by a program instructing relevant hardware. The program may be stored in computer-readable storage media such as ROM/RAM, magnetic disk, or CD-ROM.

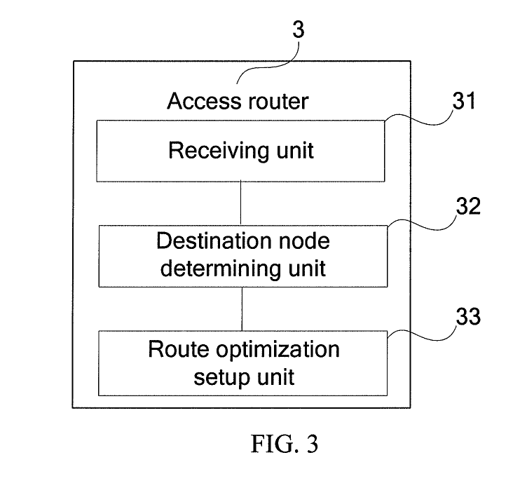

FIG. 3 shows an access router 3 disclosed herein for implementing all methods provided in the preceding method embodiments. The access router is connected between a source IP node that initiates route optimization and a destination IP node of the route optimization. The access router includes a receiving unit 31, a destination node determining unit 32, and a route optimization establishment unit 33.

The receiving unit 31 is configured to receive a test initiation message sent by the source IP node that initiates route optimization, and send the test initiation message to the destination node determining unit 32.

The destination node determining unit 32 is configured to determine the destination IP node of the route optimization according to the test initiation message sent by the receiving unit 31.

The route optimization establishment unit 33 is configured to establish route optimization between the source IP node and the destination IP node in place of the destination IP node after the destination node determining unit 32 determines the destination IP node of the route optimization.

The test initiation message may be a home test initiation message and/or a care-of test initiation message.

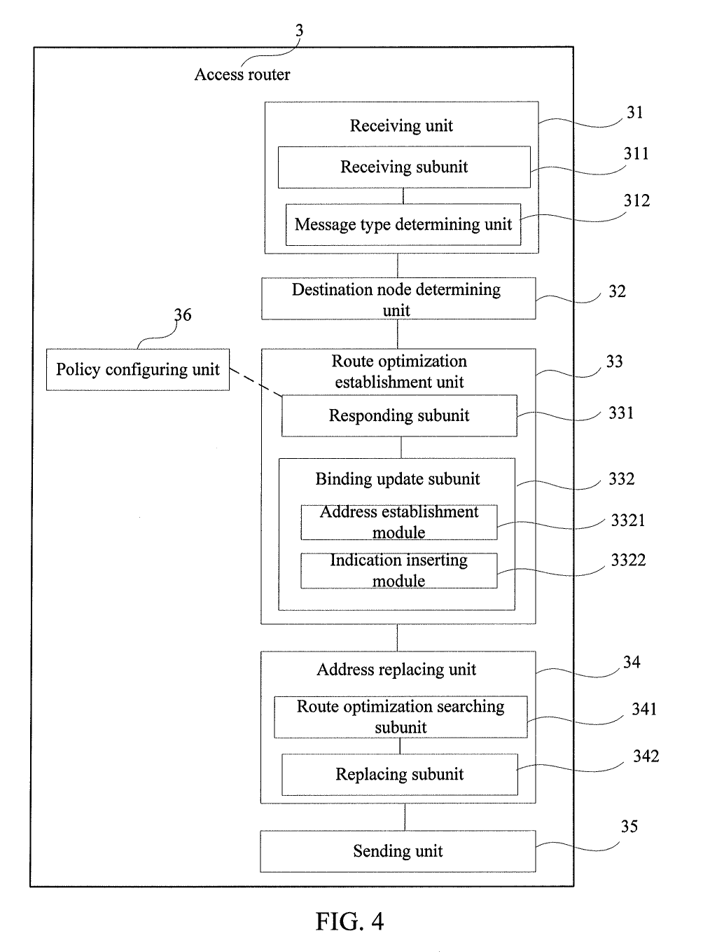

Optionally, as shown in FIG. 4, the access router 3 may further include:

a policy configuring unit 36, configured to: after the destination node determining unit 32 determines the destination IP node of route optimization, search for the locally stored policy configuration data corresponding to the destination IP node, determine necessity of establishing route optimization between the source IP node and the destination IP node in place of the destination IP node, and instruct the route optimization establishment unit 33 to establish route optimization in place of the destination IP node.

Accordingly, the route optimization establishment unit 33 is further configured to establish route optimization between the source IP node and the destination IP node in place of the destination IP node after the destination node determining unit 32 determines the destination IP node of the route optimization and receives the instruction of the policy configuring unit 36.

Further, as shown in FIG. 4, the receiving unit 31 may include a receiving subunit 311 and a message type determining subunit 312.

The receiving subunit 311 is configured to receive the IP packet sent by the source IP node, and send the IP packet to the message type determining subunit 312.

The message type determining subunit 312 is configured to determine the IP packet as a test initiation message according to the header field and the extension header field of the IP packet sent by the receiving subunit 311, and send the test initiation message to the destination node determining unit 32.

For how the message type determining subunit 312 determines the IP packet as a test initiation message, refer to the description in step 101 in the embodiment shown in FIG. 1

As shown in FIG. 4, the route optimization establishment unit 33 may include a responding subunit 331 and a binding update subunit 332.

The responding subunit 331 is configured to: after the destination node determining unit 32 determines the destination IP node of the route optimization, send a home test message to the source IP node through the home agent of the source IP node, and send a care-of test message to the source IP node, where the source IP address of the care-of test message may be set to the IP address of the destination IP node, and the destination IP address may be set to the care-of address of the source IP node.

It should be noted that, optionally, if the access router 3 includes the policy configuring unit 36, the responding subunit 331 is further configured to: after the destination node determining unit 32 determines the destination IP node of the route optimization and receives the instruction of the policy configuring unit 36, send a home test message to the source IP node through the home agent of the source IP node, and send a care-of test message to the source IP node, where the source IP address of the care-of test message may be set to the IP address of the destination IP node, and the destination IP address may be set to the care-of address of the source IP node.

The binding update subunit 332 is configured to: receive a binding update message that is sent by the source IP node after the source IP node receives the home test message and the care-of test message fed back by the responding subunit 331; store and bind the home address and the care-of address that are carried in the binding update message and the IP address of the destination IP node; and send a binding acknowledgement message to the source IP node.

Further, the binding update subunit 332 may include an address setting module 3321 and an indication inserting module 3322.

The address setting module 3321 is configured to: before the binding update subunit 332 returns the binding acknowledgement message, set the source IP address of the binding acknowledgement message to the destination IP address in the binding update message or the IP address of the access router itself, and set the source IP address of the binding message to the IP address of the destination IP node or the IP address of the access router; and/or

The indication inserting module 3322 is configured to insert indication information into the binding acknowledgement message before the binding update subunit 332 returns the binding acknowledgement message, where the indication information is used to notify the source IP node that the binding acknowledge message is a response message returned by the access router in place of the destination IP node.

As shown in FIG. 4, as an embodiment of the present disclosure, the access router 3 may further include an address replacing unit 34 and a sending unit 35.

The address replacing unit 34 is configured to: receive the first IP packet sent by the destination IP node to the source IP node, and set the destination IP address of the first IP packet to the care-of address of the source IP node after the route optimization establishment unit 33 establishes the route optimization in place of the destination IP node; and/or insert the home address of the source IP node into the extension header of the first IP packet; and transmit the first IP packet that has undergone such processing to the sending unit 35.

The home address inserted into the extension header is used to notify the source IP node that the first IP packet is a route-optimized IP packet, and this IP packet is destined for the home address of the source IP node.

The sending unit 35 is configured to send the first IP packet processed by the address replacing unit 34 to the care-of address of the source IP node.

Further, the address replacing unit 34 may include a route optimization searching subunit 341 and a replacing subunit 342.

The route optimization searching subunit 341 is configured to receive the first IP packet sent by the destination IP node to the source IP node, and determine whether route optimization exists between the destination IP address of the first IP packet and the source IP address of the first IP packet according to the destination IP address of the first IP packet and the source IP address of the first IP packet.

The replacing subunit 342 is configured to: set the destination IP address of the first IP packet to the care-of address of the source IP node after the route optimization searching subunit 341 determines that the route optimization exists between the destination IP address of the first IP packet and the source IP address of the first IP packet; and/or insert the home address of the source IP node into the extension header of the first IP packet; and transmit the first IP packet that has undergone such processing to the sending unit 35.

In practical application, depending on different application scenarios, the access router may include a mobile access gateway or a mobile router. For the specific application scenario and the corresponding route optimization method, see the description in step 209 in the embodiment shown in FIG. 2.

Through the access router provided in this embodiment, the destination IP node that receives the route optimization can still implement route optimization even if the route optimization in the mobile IPv6 protocol is not supported. The destination IP node may be any IPv6 node that supports the IPv6 protocol, and may be a fixed terminal connected in wired mode or a wireless terminal connected in wireless mode. The source mobile IP node can communicate with the destination IP node without through its own home agent; the IP packet sent by the destination IP node to the source IP node is no longer forwarded by the home agent of the source IP node, which implements route optimization. A forwarding step is deleted in the data transmission in each of the two directions, which reduces the communication delay and reduces the network load. Moreover, even if the home agent is faulty, the communication with the destination IP node still goes on properly, which enhances reliability of communication. Moreover, the home agent serves the mobile node in a one-to-many relationship. Therefore, when there are many mobile nodes, the home agent becomes a key bottleneck node, and the method provided in the embodiment of the present disclosure prevents faults caused by overload of the home agent.

It should be noted that all or part of the units described above may be integrated in a chip. All functional units in the embodiments of the present disclosure may be independent or integrated into a processing module, or two or more of the units are integrated into a module. The integrated module may be hardware or a software function module. When being implemented as a software function module and sold or applied as an independent product, the integrated module may be stored in computer-readable storage media. The storage media may be a ROM, magnetic disk, or CD-ROM accessible to a processor.

The accompanying drawings and the relevant descriptions are intended for describing the principles of the present disclosure only, but are not intended to limit the protect scope of the present disclosure. For example, message names and entities in the embodiments of the present disclosure may vary with the network, and some messages are unnecessary. Therefore, any modification, equivalent replacement, or improvement made without departing from the spirit and principles of the present disclosure shall fall within the protection scope of the present disclosure.

Although the disclosure is described through some exemplary embodiments, the disclosure is not limited to such embodiments. It is apparent that those skilled in the art can make modifications and variations to the disclosure without departing from the spirit and scope of the disclosure. The disclosure is intended to cover the modifications and variations provided that they fall in the scope of protection defined by the following claims or their equivalents.

What is claimed is:

1. A route optimization method, comprising:
receiving, by an access router, a test initiation message sent by a source IP node that initiates route optimization;
determining a destination IP node of the route optimization according to the test initiation message; and
establishing route optimization between the source IP node and the destination IP node in place of the destination IP node.

2. The method according to claim 1, wherein:
before establishing the route optimization between the source IP node and the destination IP node in place of the destination IP node, the method further comprises:
determining, by the access router, necessity of establishing the route optimization between the source IP node and the destination IP node in place of the destination IP node according to local policy configuration data.

3. The method according to claim 1, wherein:
receiving the test initiation message sent by the source IP node that initiates the route optimization comprises:
receiving the test initiation message sent by the source IP node in the form of an IP packet; and
determining the IP packet as the test initiation message according to a header field and an extension header field of the IP packet.

4. The method according to claim 1, wherein:
establishing the route optimization between the source IP node and the destination IP node in place of the destination IP node comprises:
sending, by the access router, a home test message to the source IP node through a home agent of the source IP node;
sending a care-of test message to the source IP node;
receiving a binding update message that is sent by the source IP node after the source IP node receives the home test message and the care-of test message;
storing and binding a home address and a care-of address that are carried in the binding update message and an IP address of the destination IP node; and
returning a binding acknowledge message to the source IP node.

5. The method according to claim 4, wherein:
a source IP address carried in the binding acknowledgement message is a destination IP address in the binding update message or an IP address of the access router itself.

6. The method according to claim 5, wherein:
binding acknowledgment message carries indication information, wherein the indication information is used to notify the source IP node that the binding acknowledgement message is a response message returned by the access router in place of the destination IP node.

7. The method according to claim 1 wherein:
after establishing the route optimization between the source IP node and the destination IP node in place of the destination IP node, the method further comprises:
receiving, by the access router, a first IP packet sent by the destination IP node to the source IP node;
using a care-of address of the source IP node to replace a home address of the source IP node as the destination IP address of the first IP packet; and
sending the first IP packet to the care-of address of the source IP node.

8. The method according to claim 7, wherein:
before sending the first IP packet to the care-of address of the source IP node, the method further comprises:
inserting the home address of the source IP node into an extension header of the first IP packet.

9. The method according to claim 1, wherein:
after establishing the route optimization between the source IP node and the destination IP node in place of the destination IP node, the method further comprises:
receiving, by the access router, a second IP packet sent by the source IP node to the destination IP node;
changing a source IP address of the second IP packet in the second IP packet from a care-of address of the source IP node to a home address of the source IP node; and
sending the changed second IP packet to the destination IP node.

10. An access router between a source IP node that initiates route optimization and a destination IP node of the route optimization, comprising:
a receiving unit, configured to receive a test initiation message sent by the source IP node that initiates route optimization, and send the test initiation message to a destination node determining unit;
the destination node determining unit, configured to determine the destination IP node of the route optimization according to the test initiation message sent by the receiving unit; and
a route optimization establishment unit, configured to establish route optimization between the source IP node and the destination IP node in place of the destination IP node after the destination node determining unit determines the destination IP node of the route optimization.

11. The access router according to claim 10, wherein:
the access router further comprises a policy configuring unit configured to: after the destination node determining unit determines the destination IP node of route optimization, search for locally stored policy configuration data corresponding to the destination IP node, determine necessity of establishing route optimization between the source IP node and the destination IP node in place of the destination IP node, and instruct the route optimization establishment unit to establish route optimization in place of the destination IP node; and
the route optimization establishment unit is specifically configured to establish route optimization between the source IP node and the destination IP node in place of the destination IP node after the destination node determining unit determines the destination IP node of the route optimization and receives the instruction of the policy configuring unit.

12. The access router according to claim 10, wherein the receiving unit comprises:
a receiving subunit, configured to receive an IP packet sent by the source IP node, and send the IP packet to a message type determining subunit; and
the message type determining subunit, configured to determine the IP packet as the test initiation message according to a header field and an extension header field of the IP packet sent by the receiving subunit, and send the test initiation message to the destination node determining unit.

13. The access router according to claim 10, wherein the route optimization establishment unit comprises:
a responding subunit, configured to: after the destination node determining unit determines the destination IP node of the route optimization, send a home test message to the source IP node through a home agent of the source IP node, and send a care-of test message to the source IP node; and
a binding update subunit, configured to: receive a binding update message that is sent by the source IP node after the source IP node receives the home test message and the care-of test message sent by the responding subunit; store and bind the home address and the care-of address that are carried in the binding update message and an IP address of the destination IP node; and send a binding acknowledgement message to the source IP node.

14. The access router according to claim 13, wherein the binding update subunit comprises:
an address setting module, configured to: before the binding update subunit returns the binding acknowledgement message, set the source IP address of the binding acknowledgement message to a destination IP address in the binding update message or the IP address of the access router itself.

15. The access router according to claim 13, wherein:
the binding update subunit comprises an indication inserting module configured to insert indication information into the binding acknowledgement message before the binding update subunit returns the binding acknowledgement message, wherein the indication information is used to notify the source IP node that the binding acknowledge message is a response message returned by the access router in place of the destination IP node.

16. The access router according to claim 10, further comprising:
an address replacing unit, configured to: receive a first IP packet sent by the destination IP node to the source IP node, and set a destination IP address of the first IP packet to a care-of address of the source IP node after the route optimization establishment unit establishes the route optimization in place of the destination IP node; and/or insert a home address of the source IP node into an extension header of the first IP packet; and transmit the first IP packet to the sending unit; and
a sending unit, configured to send the first IP packet processed by the address replacing unit to the care-of address of the source IP node.

17. The access router according to claim 16, wherein the address replacing unit comprises:
a route optimization searching subunit, configured to receive the first IP packet sent by the destination IP node to the source IP node, and determine whether route optimization between the destination IP address of the first IP packet and the source IP address of the first IP packet exists according to the destination IP address of the first IP packet and the source IP address of the first IP packet; and
a replacing subunit, configured to: set the destination IP address of the first IP packet to the care-of address of the source IP node after the route optimization searching subunit determines that the route optimization between the destination IP address of the first IP packet and the source IP address of the first IP packet exists, and/or insert the home address of the source IP node into the extension header of the first IP packet; and transmit the first IP packet to the sending unit.
